(19) United States
(12) Patent Application Publication
(10) Pub. No.: US 2021/0287352 A1
(43) Pub. Date: Sep. 16, 2021

(54) Minimally Supervised Automatic-Inspection (AI) of Wafers Supported by Convolutional Neural-Network (CNN) Algorithms

(71) Applicant: NEXTEC TECHNOLOGIES 2001 LTD., Karmiel (IL)

(72) Inventors: Eran Calderon, Herzliya (IL); Sergei Lanzat, Akko (IL); Irena Kemarski, Haifa (IL); Lior Haim, Eilat (IL); Longhua An, Wuxi (CN)

(21) Appl. No.: 16/838,055

(22) Filed: Apr. 2, 2020

(30) Foreign Application Priority Data
Mar. 16, 2020 (CN) 2020101808872

(51) Int. Cl. G06T 7/00; G06K 9/62; G06T 5/00

(52) U.S. Cl. CPC G06T 7/001; G06K 9/6256; G06K 9/6267; G06T 2207/20224; G06T 2207/20081; G06T 2207/20084; G06T 2207/30148; G06T 5/003

(57) ABSTRACT

The application relates to minimally supervised automatic-inspection (AI) of wafers supported by convolutional neural-network (CNN) algorithms. Computational apparatus includes a memory and a processor. The memory is configured to hold one or more reference images of an electronic circuit. The processor is configured to (a) generate from the reference images a set of training images by embedding visual artifacts of defects in the reference images, (b) train a neural network (NN) model using the set of training images, and (c) identify, using the trained NN model, defects in scanned images of replicas of the electronic circuit.

### CROSS-REFERENCE TO RELATED APPLICATIONS

This application claims priority from Chinese Invention Patent Application No. 2020101808872, filed Mar. 16, 2020, whose disclosure is incorporated herein by reference.

### FIELD OF THE INVENTION

The present invention relates generally to machine learning techniques, and in particular to the use of deep learning techniques in automatic inspection of defects in electronic circuits.

### BACKGROUND OF THE INVENTION

Convolutional neural networks (CNNs), which are a subclass of artificial neural networks (NNs), are considered more suitable for practical implementations compared with other classes of NNs. In particular, CNNs are studied for various potential applications in fields such as image and natural language processing, in which CNNs may have particular practical advantages in terms of runtime and required computation resources.

In principle, CNN architectures reduce the complexity and duration of calculations by applying convolutional steps that lower the number of variables in the neural network model while retaining essential features of the studied objects (e.g., images). Although convolutions constitute the backbone of CNN architectures, we stress that these networks also encompass some other elementary operations (e.g., “Transposed convolutions,” “Pooling” and “Batch renormalizations”) and techniques (e.g., “Dropouts,” which reduce overfitting problems over small datasets).

Moreover, recent CNN methods aim at reducing model and database customizations often required in deep learning solutions, so as to achieve fully automated NN based products and thereby to extend the range of practical (e.g., commercial) applications of NNs.

A supervised machine learning approach, in particular the training of a CNN, requires sufficient training data, in order to achieve a good generalization and avoid overfitting. Unfortunately, attaining sufficient reliable authentic training data is not always possible due to possible constraints. Some solutions that require sufficient training data, therefore aim at artificially increasing the amount of training data, so as to achieve good performance of the NN.

To build a reliable NN model using very little training data, image augmentation is usually required. Image augmentation artificially creates training images through different ways of processing or combination of multiple processing, such as random rotations, shifts, shear and flips, etc. Additional image augmentation, instead or on top of the ones described above, can be performed by employing a generative approach. A notable approach to this type of augmentation is using a generative deep learning model, such as variational autoencoder model or a generative adversarial network model. For example, a generative adversarial network model can augment images using an iterative process involving a “competition” between two neural networks, as described by Goodfellow et al. in “Deep Learning,” MIT Press, 2016, chapter 20, pp. 651-716.

### SUMMARY OF THE INVENTION

An embodiment of the present invention provides a computational apparatus including a memory and a processor. The memory is configured to hold one or more reference images of an electronic circuit. The processor is configured to (a) generate from the reference images a set of training images by embedding visual artifacts of defects in the reference images, (b) train a neural network (NN) model using the set of training images, and (c) identify, using the trained NN model, defects in scanned images of replicas of the electronic circuit.

In some embodiments, the NN model is a convolutional network model (CNN) model.

In some embodiments, in generating the training images, the processor is further configured to augment the reference images having the embedded visual artifacts. In other embodiments, in generating the training images, the processor is further configured to image-subtract the augmented reference images, wherein image-subtraction of an augmented reference image includes subtracting from the augmented image a defect-free reference image.

In an embodiment, the processor is configured to augment the reference images by generating superpositions of selected reference images by applying a generative deep learning (GDL) algorithm to the selected reference images.

In another embodiment, the processor is further configured to optically correct blur in one or more of the reference images by applying a generative deep learning (GDL) algorithm.

In some embodiments, the processor is further configured to label one or more of the reference images embedded with the visual artifacts according to one of classification, object-detection, and segmentation.

In some embodiments, the electronic circuit is part of a die of a wafer.

In an embodiment, the processor is configured to identify the defects in a scanned image by applying image-subtraction to the scanned image, wherein image-subtraction of a scanning image includes subtracting from the scanned image a defect-free reference image.

In another embodiment, at least one of the reference images includes one of (i) a scanned image of an actual replica of the electronic circuit and (ii) a “golden-die” generated by scanning of several replicas.

In yet another embodiment, the processor is configured to identify defects in images of replicas of the electronic circuit that were scanned in a rotational scanning mode.

There is additionally provided, in accordance with another embodiment of the present invention, a method including holding in a memory one or more reference images of an electronic circuit. A set of training images is generated from the reference images by embedding visual artifacts of defects in the reference images. A neural network (NN) model is trained using the set of training images. Using the trained NN model, defects are identified in scanned images of replicas of the electronic circuit.

The present invention will be more fully understood from the following detailed description of the embodiments thereof, taken together with the drawings in which:

### BRIEF DESCRIPTION OF THE DRAWINGS

FIG. 1 is a block diagram schematically illustrating an automated wafer inspection system configured to use convolutional neural network (CNN) defect detection algorithms, according to an embodiment of the present invention;

FIG. 2 is a diagram of an array of reference patch-images that covers a single die, and of multiple respective neural network (NN) models to be trained using the reference images, according to an embodiment of the present invention;

FIGS. 3A and 3B are diagrams of one of the reference images of FIG. 2 before and after being embedded with artificial defects, according to an embodiment of the present invention;

FIGS. 4A and 4B are an inspection image and a diagram of a respective multilabel segmentation mask generated from the inspection image, according to an embodiment of the present invention;

FIG. 5 is a diagram that schematically illustrates a rotational scanning mode of a wafer, according to an embodiment of the present invention;

FIGS. 6A and 6B are diagrams illustrating a blurred reference image of FIG. 2 and the image after being brought into focus by a generative deep learning (GDL) model, according to an embodiment of the present invention;

FIG. 7 is a flow chart that schematically illustrates a method to detect defects in an electronic circuit using a minimally supervised convolutional neural network (MS-CNN) model, according to an embodiment of the present invention; and

FIGS. 8A-8C are schematic block diagrams that describe steps of image augmentation by a generative deep learning (GDL) model, according to embodiments of the present invention.

### DETAILED DESCRIPTION OF EMBODIMENTS

### Overview

Embodiments of the disclosed invention provide implementations of (minimally) supervised convolutional neural network algorithms. Supervised learning is the machine learning task of accomplishing a learning goal (realization of some function) through labeled training examples—pairs of input objects and corresponding desired output values.

Automatic inspection (AI) for quality control of manufactured electrical circuits, such as patterned wafers and printed circuit boards (PCB), is regularly done in manufacturing facilities. The use of AI to detect defects (e.g., cracks, scratches, voids, residue deposits) between manufacturing steps improves yield and lowers manufacturing costs. However, setting up and maintaining an AI operation is technically challenging and labor intensive. To begin with, existing AI systems must be customized per product and per manufacturing line. In addition, existing AI systems generate a high rate of false alarms due to, for example, harmless recurring process variations (e.g., in a conductor linewidth) between manufactured circuits and a reference circuit used by the AI system for quality control.

One possible way of detecting defects is to use a subtraction-image of the manufactured circuit, which is derived by subtracting an image of a defect-free circuit (also known as a “golden-die”) from a scanning (i.e., inspection) image. Due to the above-mentioned benign process variations, the subtraction image (i.e., difference image) often includes gross features, e.g., lines, that may be erroneously identified by the AI system as defects. Additional complications arise from tight alignment requirements of the AI apparatus, such as of a camera used by the AI system, relative to the inspected specimens (e.g., wafer dies).

An AI system based on a neural network (NN) model (e.g., on a NN-based inspection algorithm) can potentially resolve most or all of the above-mentioned difficulties. Among classes of NN models, convolution neural network (CNN) classes may be considered best suited for image analysis. In particular, the computational and memory requirements to train a CNN model are within reach, as opposed to other NN models. The practicality of CNN models is due to the convolution operation in the CNN model, which can reduce the complexity of an AI by orders of magnitude, allowing the network to perform the AI task within an acceptable time and cost.

Embodiments of the present invention that are described hereinafter provide defect inspection systems and methods that apply minimally supervised NNs, such as minimally supervised convolutional neural networks (MS-CNNs), to detect defects in electronic circuits, such as in patterned wafers and PCBs.

The AI task which corresponds to the defect detection solution can be categorized into either of the following:

a) Classification—determination that a sample image is good or bad;

b) Object detection—locating possible defects in an image sample;

c) Segmentation—an assignment of a label to each pixel of the input sample, yielding an associated mask. Such an output marks the defects, and can possibly also label their type and nature (e.g., defect being on a conductive line or on a mesa or on a substrate). The segmentation masks may be further analyzed to identify the root-causes of defects.

Alternatively, or additionally to generating segmentation masks, for the purpose of marking defects, the output may include “heat maps” that assist in readily identifying regions of interest where defects are found. Heat maps can be advantageous since they may indicate a cause of the defects without immediately performing the intensive computations involved in segmentation mask generation.

Correspondingly an output of the disclosed CNN technique may correspond to either of these type of outputs (despite that the outputs are of significantly different form, while the training scheme is almost the same). Deep CNN algorithms can fulfill any of the aforementioned tasks, i.e., classification (VGG, Resnet, Inception, etc.), Object detection (Faster RCNN, SSD, etc.), segmentation (FCNN, Unet, DeepLab, etc.). These are supported by many published works.

The disclosed MS-CNN based inspection technique requires only a limited number of reference images of the non-defect circuit as an input. Labor intensive customization efforts, including human marking of defects in many training samples for the training stage, are not an essential part of the use of the disclosed AI systems and methods, and any minor customization, which may come later, in particular the inclusion of some few additional marked/labeled not defect-free inputs, is only for the purpose of improvement and fine-tuning of the disclosed AI systems and CNN-based methods.

The disclosed minimal supervision approach to AI hides an underlying, fully supervised, approach. The limited number of reference images are uploaded to a processor and the processor embeds artificial defects in the reference images (i.e., embeds visual artifacts of defects in the reference images). The processor then augments the resulting artificial images to create a set of images suitable for training the neural network. The image augmentation step may comprise, for example, light random changes such as flips, translations, rotations, distortions, scaling, cropping, addition of Gaussian noise, and changes in a perceived illumination (e.g., brightness).

Additionally, or alternatively, the processor may also apply random changes to the artificial defects that are randomly embedded in the reference images. The random changes may be similar to the changes listed above, yet allowing significantly more extensive distortions. Finally, the processor generates, from the artificial-defect-embedded and augmented images, a respective set of subtraction-images, as described above. The order of operations (e.g., embedding artificial defects, augmentation, and image-subtraction) may vary.

In another embodiment, in addition to image augmentation by the methods described above, the processor may apply a Generative Deep Learning (GDL) model to further augment the images (i.e., in ways that go beyond the variations introduced above, such as linear transformations). For example, using a convolutional Generative Adversarial Network (cGAN) type of GDL model enables the production of a set of fake images that are suppositions of the aforementioned augmented images and thereby reflect potential process variations in manufacturing that are not otherwise covered by the original training set of augmented images.

In yet another embodiment, instead of augmenting reference images, the disclosed MS-CNN technique augments one or more of the scanning inspection images themselves, e.g., without off-line preparatory steps that require a golden-die. In other words, one or more of the reference images may comprise scanned images of actual replicas of the electronic circuit. In such a case, the MS-CNN model is trained to identify defects using a statistical model of a distribution of inspection images of less-defected or more-defected dies from the inspection line. To date, however, using the aforementioned reference images is generally a more practical approach in terms of the required computation power and duration of the inspection steps.

### Automatic Inspection System Description

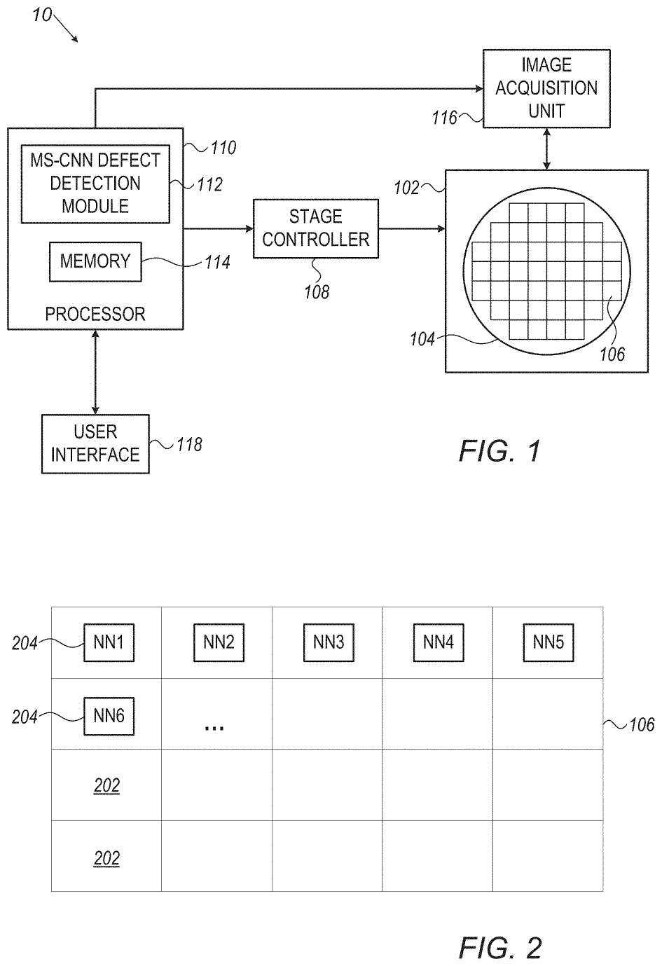

FIG. 1 is a block diagram schematically illustrating an automated wafer inspection system 10 configured to use convolutional neural network (CNN) defect detection algorithms, according to an embodiment of the present invention. In the present example, a processor 110 is optimized for machine-learning (ML), aimed at ML inference chores and/or ML training. The architecture of processor 110 is typically based on dedicated graphical processing units (e.g., on multiple GPUs). However, the disclosed AI techniques are also applicable to a wide variety of processor architectures.

FIG. 1 shows an otherwise typical automated wafer inspection system comprising a stage 102 on which a wafer 104 comprising dies 106 is mounted. Stage 102 moves the wafer horizontally and vertically (e.g., performing X-Y movements) while being controlled by a stage controller 108 according to a procedure commanded by processor 110. Alternatively, an image acquisition unit 116 may be moved over a wafer held in one place.

Image acquisition unit 116 acquires images of the inspected dies, and the images are stored in a memory 114. A reference-die (also referred to as a golden-die) clear from defects is generated by the processor (or otherwise the user may specify defect-free dies), together with a training set of images (e.g., images containing embedded artificial defects) that processor 110 generated from one or more reference images of the dies to be inspected.

Stage 102 can move stepwise in small increments, allowing unit 116 to acquire a single patch-image within each step, or move continuously along lines, allowing unit 116 to take images of complete strip-images (e.g. via TDI camera).

Typical dimensions of a die are 10x10 millimeters, whereas searched defect sizes are typically four orders of magnitude smaller, so hundreds of high-resolution images may be taken to cover each die (this of course depends on the magnification); alternatively, using line scans, with only few strip images, the whole wafer (in particular, the whole set of dies) can be covered. Using an MS-CNN defect detection module 112 that is uploaded with an MS-CNN algorithm, processor 110 analyzes (e.g., classifies) each image (or a part of an image) within a short duration.

User interface 118 may include communication means (e.g., messaging tools to a mobile phone or a web application) to remotely configure system 10 (e.g., to have AI system 10 generate a training set of images of a new type of die to inspect) and audio-visual means to alert a user in case of a manufacturing problem, and thus system 10 may be operated remotely with minimal human intervention.

In various embodiments, the different electronic elements of the system shown in FIG. 1 may be implemented using suitable hardware, such as using one or more discrete components, one or more Application-Specific Integrated Circuits (ASICs) and/or one or more Field-Programmable Gate Arrays (FPGAs). Some of the functions of the disclosed processors, units, and modules, e.g., some or all functions of processor 110 and of MS-CNN defect detection module 112, may be implemented in one or more general purpose processors, which are programmed in software to carry out the functions described herein. The software may be downloaded to the processors in electronic form, over a network or from a host, for example, or it may, alternatively or additionally, be provided and/or stored on non-transitory tangible media, such as magnetic, optical, or electronic memory.

### A Single or Multiple Dedicated Neural-Network Architecture for Inspection

As noted above, a single image that covers an entire die cannot provide the required resolution to inspect the die. Thus, during an inspection session, system 10 takes multiple patch-images or strip-images at fixed relative coordinates to generate an array of patch images that fully covers the wafer's dies (e.g., a full die image is constructed by stitching together multiple patch-images, or by cropping an outcome of stitching several strip-images).

Furthermore, at present, the input of the NN architectures which is employed herein is optimized to analyze relatively small images. This does not hinder the NN approach from analyzing larger images (without need in rescaling), in view of the following methods.

FIG. 2 is a schematic diagram of an array of reference patch-images 202 that covers a single die 106, and of respective multiple neural network (NN) models 204 to be trained by reference patch images 202 after images 202 are embedded with artificial defects and augmented, according to an embodiment of the present invention. For each patch of die 106, the reference images 202 are acquired (by system or by another system) from different angles and positions, in order to make system 10 support inspection images taken at different angles and from arbitrary positions.

Different patches of reference die 106 may include different circuitries. In the shown embodiment, multiple neural networks (NN1, NN2, . . . ) are individually trained by a processor using respective reference patch-images to optimize the inspection. Thus, each of NN1, NN2, . . . is associated with single patch coordinates and each patch is inspected using a dedicated NN configuration.

Other realizations of such multiple NN approach are possible; for example, using a single, however multi-input, NN, such that each of the inputs is processes by a dedicated branch of the NN, and eventually features are concatenated.

Alternatively, as part of the input to the NN the disclosed techniques include a differences image (between the inspected patch-image to a corresponding reference patch-image which is clear from defects). In the difference image, a defect is identified not by the individual features of the images which were subtracted, but by their difference, hence the exact location at which the images were acquired is immaterial. This approach can also be incorporated into a semi-CNN inference, where the analysis starts by computing difference images, and continues by locating suspected defects, followed by a further applying a NN to generate a label (which determines if the suspected area corresponds to a defect, and to mark it if that is desired).

### Generating a Training Set of Images by Embedding Artificial Defects

As noted above, a processor has to embed artificial defects in order to generate artificial reference images.

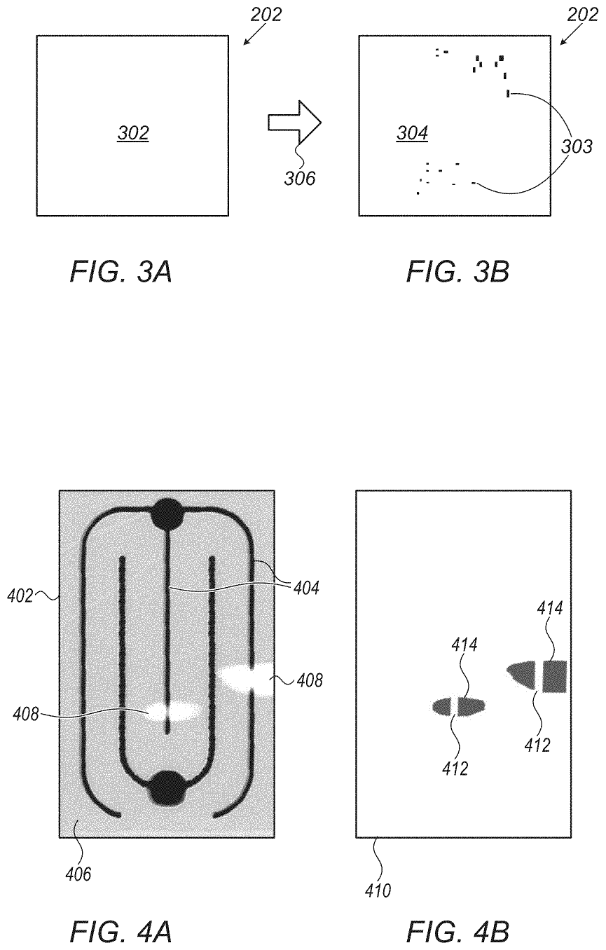

FIGS. 3A and 3B are diagrams of one of the reference images 202 of FIG. 2 before (302) and after (304) being embedded with artificial defects 303, according to an embodiment of the present invention.

Artificial-defect-embedded reference images 304 further undergo augmentation (not seen), to generate a large database of artificial images, as described above. The images of the resulting set of artificial images each further undergo image-subtraction and then are used in training the CNN model to detect defects in scanning images.

### Multilabel Segmentation Masking

As further noted above, segmentation masks are tools used for defect detection (e.g., prior to classification) in which a processor generates a “semantic segmentation mask” which, in essence, associates a label (or a class) to each pixel of the input image.

Although for most purposes it is sufficient to consider two labels, “defect” or “not-defect,” (for which the generated mask is a binary black-white image), additional pixel labels may be used to correspond to different regions of interest on the input image, in which case the generated mask will be a multilevel (e.g., multicolor) image.

FIGS. 4A and 4B are an inspection image 402 and a diagram of a respective multilabel segmentation mask generated from inspection image 402, according to an embodiment of the present invention. The shown inspection image includes conductive lines 404 on a substrate 406. The processor generates mask 410 by employing a convolutional neural network for image segmentation, which essentially teaches the machine to “understand” what is the background (belonging to the reference image, such as lines 404) and what is not, hence considered the foreground. As seen, the manufactured element has identified two defects 408.

Using multilabel segmentation, further classification of the foreground into regions of interest is achieved. Multilabel segmentation masks are used in order to distinguish between regions of different natures, where, in mask 410, the defect on an electrode 404 is marked by a light shade 412 (or a color), while a defect outside electrode 404 is marked in a dark shade 414 (or another color).

### Rotational Scanning Mode

Ordinarily optical scanning is done by scanning a wafer horizontally and vertically, e.g., by moving the camera along lines until the wafer is covered, as described in FIG. 1. The linear scan mode imposes some limitations on the scanning speed.

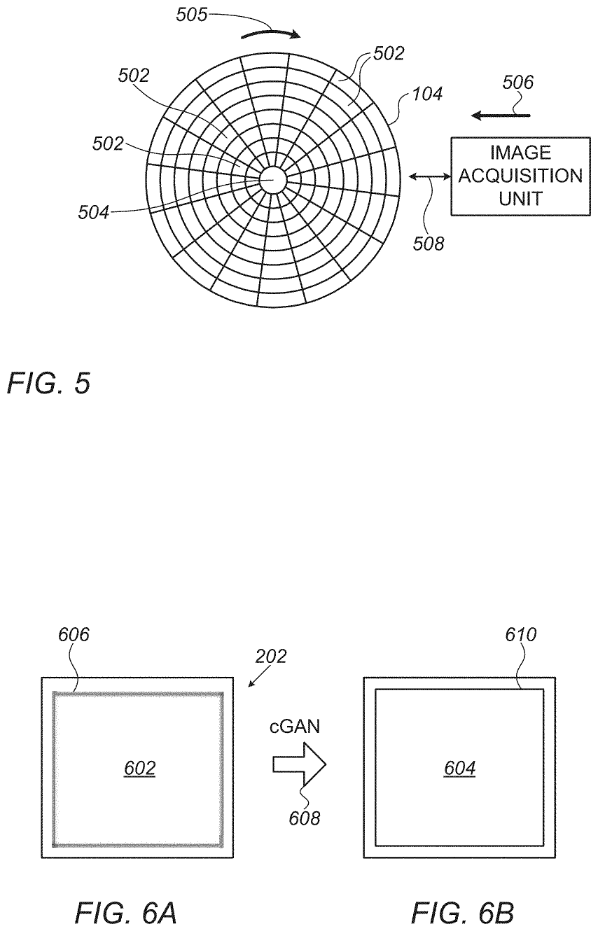

FIG. 5 schematically illustrates a rotational scanning mode of wafer 104, according to an embodiment of the present invention. In the disclosed embodiment, wafer 104 is mounted on a stage that rotates (505) the wafer. An image acquisition unit is moved (506) step-wise radially and takes (508) images until wafer 104 is covered. As seen, the resulting array of images (502, 504), whether reference or scanning images, is made of angular-section patch-images, rather than rectangular patch-images. Typically, such an approach would be rejected due to the algorithmic complications involved, since patch-images are acquired at different relative angles.

However, a processor using the disclosed CNN algorithms can detect wafer defects, considering the approach of dedicated NN to specific regions, without the actual necessity of a reference image for subtraction in order to get a difference image (which is crucial, since the assignment of a corresponding reference patch-image requires a very sophisticated alignment in order to match a scanned patch-image to a patch-image from the reference die, when using rotational scanning). Yet we do not exclude the possibility of using a reference image after-all.

### Optical Quality Corrections and Enhancement Using Neural Networks

Using generative deep learning methods, the disclosed approach may be used to amend the optical quality of the scanned images of the defects acquired by the AI system.

For example, some level of image blurring may be caused by various reasons, such as motion or poor focus. Even minute amounts of blurring may degrade the performance of an automated inspection system, as visibility of small defects is most susceptible to blurring. Using CNN-based methods, an embodiment of the present invention corrects the image to sharpen the focus.

FIGS. 6A and 6B are diagrams illustrating a blurred reference image 602 of FIG. 2 and the image (604) after being brought into focus (608) by a generative deep learning (GDL) model, according to an embodiment of the present invention. As seen, edge features 606 of image 602 are blurred, instead of being sharp. Focus inconsistencies of acquired images are corrected by the disclosed embodiment using a GDL model, such as cGAN, for the deblurring of an image or parts of an image. As seen in FIG. 6B, blurred edges 606 are transformed into sharp edges 610.

Furthermore, generative deep learning methods can be used for image denoising to further improve detection capability of actual defects. In some cases, generative deep learning methods, such as the cGAN model, can be further used in a so-called “super resolution” functionality, in which the model adds details which the model determines to be missing, so as to increase image resolution.

Using generative deep learning methods, the disclosed approach may also be used to solve minor optical problems of the AI system itself (e.g., to compensate for slight defects in a lens, or compensate for minor misalignments).

### Minimally Supervised AI of Wafer Supported by CNN Algorithm

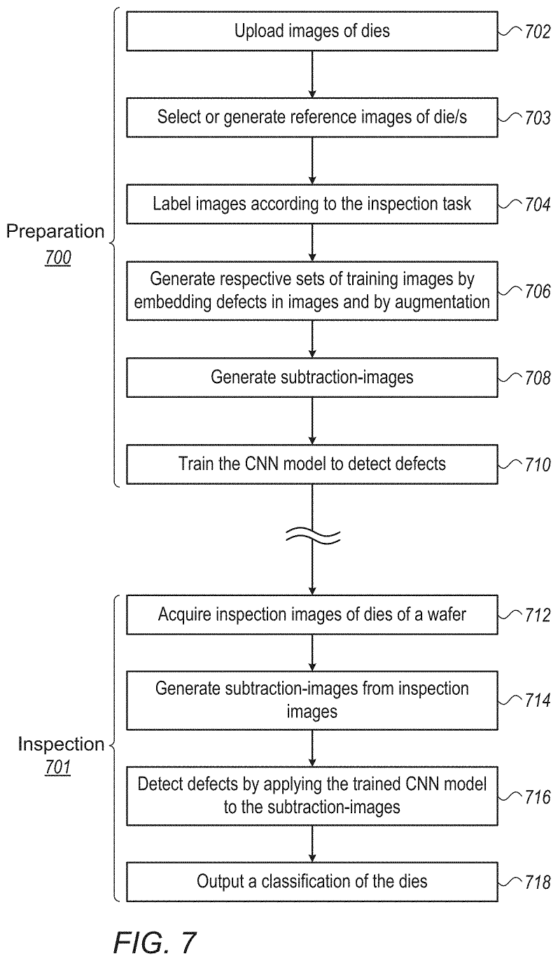

FIG. 7 is a flow chart that schematically illustrates a method to detect defects in an electronic circuit using a minimally supervised convolutional neural network (MS-CNN) model, according to an embodiment of the present invention. The algorithm, according to the presented embodiment, carries out a process that is divided into a training phase 700 and an inspection phase 701.

The training begins with an image uploading step 702, in which images of an electronic circuit are uploaded to a processor (e.g., processor 110). At a reference image selection step 703, the user selects or generates reference images. At step 703, the user can obtain a “golden-die” reference image (i.e., a defect-free die image) using common averaging/filter methods, or by explicitly choosing images of a die which are deemed free from defects. The golden-die image is stored, and the system is ready for training.

At a labeling step 704, the user assigns a label for each patch (having the size of the NN input) of a reference image, such as a pass/fail classification label, to assign a respective task. Other labels are possible, such as to further identify the type and location of a defect that caused failure. If the training is based on defect-free images, for example on the golden-die image, then the processor assigns the same label (i.e., clear from defects) to all patches from which it is composed.

Next, the processor generates, from the labeled reference images, respective sets of training images by embedding artificial defects and by augmentation of the labeled reference images, at an image training set generation step 706. Next, in an optional step, the processor generates, from the training images, image-subtracted training images by subtracting from each image of the training set a respective image of the golden die, at an image subtraction step 708.

Using a training set of labeled tuples of images (where a tuple can contain the inspected patch-image, the associated patch-image from the golden die, as well as their difference), the processor trains the MS-CNN model to detect defects, as described above, at a CNN training step 710.

Inspection phase 701 begins with the AI system (e.g., system 10) scanning the wafer (the image acquisition yields a patch-image or a strip image), at a wafer scanning step 712. The processor turns sub patch-images of the acquired images into tuples of images (of the form used for feeding the CNN in the training phase) which are fed as batches of tuples into the CNN, at an image inputting step 714. The tuple should contain the difference image, or at least images from which information about the difference image can be obtained, so that defects can be spotted.

The processor then applies the already trained MS-CNN models to detect potential defects captured by the image inputting step of step 714, at a defect detection step 716. Finally, the processor outputs a report in which the processor classifies each die as proper or defective.

The flow chart of FIG. 7 is brought by example, purely for the sake of clarity. Additional or alternative embodiments may include steps such as further analysis of proper and defective dies, to, for example, bin proper dies and to perform root cause analysis. Further analysis may require the generation of multi-level segmentation masks. In another embodiment, the processor may generate a heat map for each die, for example, to rapidly identify a cause of systematic defects (e.g., that reoccur in the dies at a same region).

While the inspection process described by FIG. 7 is of wafer dies, other electronic circuits, such as circuitries of a PCB, may be inspected in a similar way.

As already noted above, fake images (which are also artificial images) can be generated (e.g., augmented) from any existing images to reflect other process variations in the dies aside from possible defects. Such variations are unavoidable; these changes can be expressed in various ways, such as in slight differences in the size of parts of a die (or relative sizes), as well as differences in its colors, or even slight changes in the wafer geometry (e.g., its depth or plane angle). Artificial images enhance the capabilities of the above-described MS-CNN models (which were fed with just a few authentic samples for training) to distinguish real defects from benign process variations.

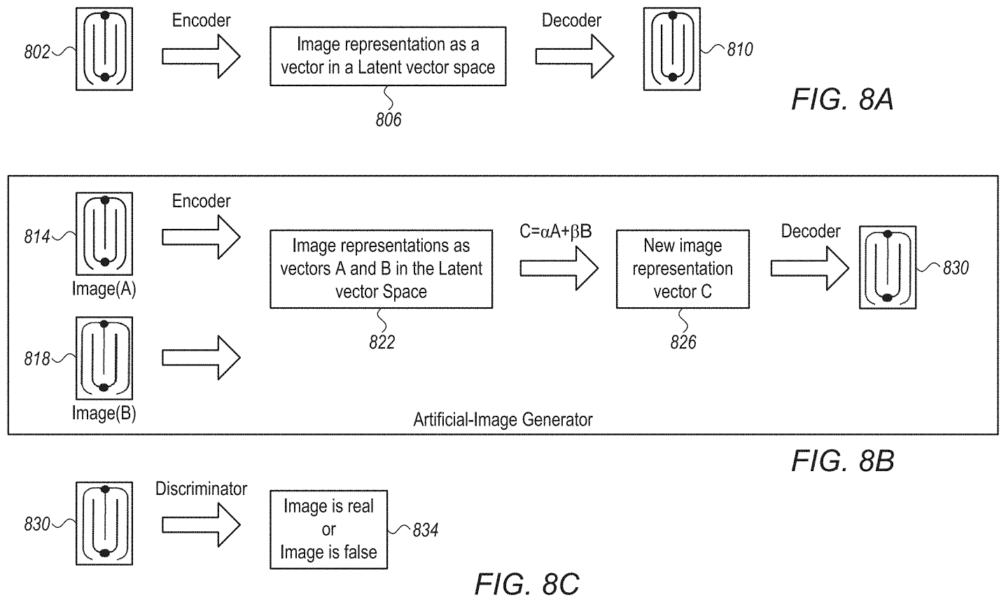

FIGS. 8A-8C are schematic block diagrams that describe steps of image augmentation by a generative deep learning (GDL) model, according to embodiments of the present invention. FIG. 8A shows a reference image 802 of a portion of a die, which is encoded into a vector of a “latent” vector space 806. A trained decoder is able to accurately reconstruct image 802 from the representation vector of image 802, and to generate reconstructed image 810.

In FIG. 8B, two reference images, Image(A) 814 and Image(B) 818 of a same die location but of different dies (e.g., dies from different wafers). As can be seen, there is a scaling-like effect that causes Image(A) 814 and Image(B) 818 to differ along a horizontal axis of the images.

In FIG. 8B, Image(A) 814 and Image(B) 818 are encoded into lateral space 822 as vectors A and B. Using vector-space properties of the latent space, a linear combination vector C 826, C=αA+βB (α and β being real numbers) is also an image representation only of an image that is fake rather than taking an image and subsequently augmenting it. In such a case, the trained decoder generates a fake image 830 from vector C.

A trained discriminator is capable of determining (834) if fake image 830 is real in the sense that it is suitable for inclusion in a set of training images, or is a false image that should not be used for training.

By generating fake images, such as image 830, that represent possible process variations, the above-described MS-CNN models are equipped with an increased set of training images, including images with properties different from those of images augmented by the above-mentioned traditional augmentation methods.

Although the embodiments described herein mainly address automatic inspection of electronic circuits, the methods and systems described herein can also be used in other applications, such as in inspection of camera filters, LEDs, or any other product line scanned by an optical system similar to the system we presented, in which the images of defected items can be identified as relatively small deviations from a reference sample (such as the golden-die).

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. Computational apparatus, comprising:
a memory, which is configured to hold one or more reference images of an electronic circuit; and
a processor, which is configured to:
generate from the reference images a set of training images by embedding visual artifacts of defects in the reference images;
train a neural network (NN) model using the set of training images; and
identify, using the trained NN model, defects in scanned images of replicas of the electronic circuit.

2. The computational apparatus according to claim 1, wherein the NN model is a convolutional network model (CNN) model.

3. The computational apparatus according to claim 1, wherein, in generating the training images, the processor is further configured to augment the reference images having the embedded visual artifacts.

4. The computational apparatus according to claim 3, wherein, in generating the training images, the processor is further configured to image-subtract the augmented reference images, wherein image-subtraction of an augmented reference image comprises subtracting from the augmented image a defect-free reference image.

5. The computational apparatus according to claim 3, wherein the processor is configured to augment the reference images by generating superpositions of selected reference images by applying a generative deep learning (GDL) algorithm to the selected reference images.

6. The computational apparatus according to claim 1, wherein the processor is further configured to optically correct blur in one or more of the reference images by applying a generative deep learning (GDL) algorithm.

7. The computational apparatus according to claim 1, wherein the processor is further configured to label one or more of the reference images embedded with the visual artifacts according to one of classification, object-detection, and segmentation.

8. The computational apparatus according to claim 1, wherein the electronic circuit is part of a die of a wafer.

9. The computational apparatus according to claim 1, wherein the processor is configured to identify the defects in a scanned image by applying image-subtraction to the scanned image, wherein image-subtraction of a scanning image comprises subtracting from the scanned image a defect-free reference image.

10. The computational apparatus according to claim 1, wherein at least one of the reference images comprises one of (i) a scanned image of an actual replica of the electronic circuit and (ii) a “golden-die” generated by scanning of several replicas.

11. The computational apparatus according to claim 1, wherein the processor is configured to identify the defects in images of replicas of the electronic circuit that were scanned in a rotational scanning mode.

12. A method, comprising:
holding in a memory one or more reference images of an electronic circuit;
generating from the reference images a set of training images by embedding visual artifacts of defects in the reference images;
training a neural network (NN) model using the set of training images; and
identifying, using the trained NN model, defects in scanned images of replicas of the electronic circuit.

13. The method according to claim 12, wherein the NN model is a convolutional network model (CNN) model.

14. The method according to claim 12, wherein generating the training images comprises augmenting the reference images having the embedded visual artifacts.

15. The method according to claim 14, wherein generating the training images comprises image-subtracting the augmented reference images, wherein image-subtraction of an augmented reference image comprises subtracting from the augmented image a defect-free reference image.

16. The method according to claim 14, wherein augmenting the reference images comprises generating superpositions of selected reference images by applying a generative deep learning (GDL) algorithm to the selected reference images.

17. The method according to claim 12, and comprising optically correcting blur in one or more of the reference images by applying a generative deep learning (GDL) algorithm.

18. The method according to claim 12, and comprising labeling one or more of the reference images embedded with the visual artifacts, according to the specified objective label: classification, object-detection, or segmentation.

19. The method according to claim 12, wherein the electronic circuit is part of a die of a wafer.

20. The method according to claim 12, wherein identifying the defects in a scanned image comprises applying image-subtraction to the scanned image, wherein image-subtraction of a scanning image comprises subtracting from the scanned image a defect-free reference image.

21. The method according to claim 12, wherein at least one of the reference images comprises one of (i) a scanned image of an actual replica of the electronic circuit, and (ii) a “golden-die” generated by scanning of several replicas.

22. The method according to claim 12, wherein identifying the defects comprises identifying the defects in images of replicas of the electronic circuit that were scanned in a rotational scanning mode.
